(19) United States
(12) Patent Application Publication
(10) Pub. No.: US 2025/0095259 A1
(43) Pub. Date: Mar. 20, 2025

(54) AVATAR ANIMATION WITH GENERAL PRETRAINED FACIAL MOVEMENT ENCODING

(71) Applicant: QUALCOMM Incorporated, San Diego, CA (US)

(72) Inventors: Ke-Li CHENG, San Diego, CA (US); Wei-Lun CHANG, Hsinchu (TW); Michel Adib SARKIS, San Diego, CA (US)

(21) Appl. No.: 18/470,032

(22) Filed: Sep. 19, 2023

(51) Int. Cl. G06T 13/40; G06V 40/16

(52) U.S. Cl. CPC G06T 13/40; G06V 40/174

(57) ABSTRACT

Techniques and systems are provided for generating a representation of a face. For instance, a process can include obtaining one or more images of a face. The process can further include generating an encoded expression representing an expression of the face, wherein predetermined characteristics of the face remain constant relative to the encoded expression. The process can further include mapping the encoded expression to a corresponding expression of a facial model. The process can further include generating the representation of the facial model based on the encoded expression.

### FIELD

The present disclosure generally relates to systems and techniques for generating three-dimensional (3D) models. For example, aspects of the present disclosure relate to avatar animation using a general pretrained facial movement encoding for faces.

### BACKGROUND

Many devices and systems allow a scene to be captured by generating frames (also referred to as images) and/or video data (including multiple images or frames) of the scene. For example, a camera or a computing device including a camera (e.g., a mobile device such as a mobile telephone or smartphone including one or more cameras) can capture a sequence of frames of a scene. The frames and/or video data can be captured and processed by such devices and systems (e.g., mobile devices, IP cameras, etc.) and can be output for consumption (e.g., displayed on the device and/or other device). In some cases, the frame and/or video data can be captured by such devices and systems and output for processing and/or consumption by other devices.

A frame can be processed (e.g., using object detection, recognition, segmentation, etc.) to determine objects that are present in the frame, which can be useful for many applications. For instance, a model can be determined for representing an object in a frame and can be used to facilitate effective operation of various systems. Examples of such applications and systems include augmented reality (AR), robotics, automotive and aviation, three-dimensional scene understanding, object grasping, object tracking, in addition to many other applications and systems.

### SUMMARY

Systems and techniques are described herein for generating a textured a three-dimensional (3D) facial model. In one illustrative example, a method for generating a representation of a face is provided. The method includes: obtaining one or more images of a face; generating an encoded expression representing an expression of the face, wherein predetermined characteristics of the face remain constant relative to the encoded expression; mapping the encoded expression to a corresponding expression of a facial model; and generating the representation of the facial model based on the encoded expression.

As another example, an apparatus for generating a representation of a face is provided. The apparatus includes at least one memory and at least one processor coupled to the at least one memory. The at least one processor being configured to: obtain one or more images of a face; generate an encoded expression representing an expression of the face, wherein predetermined characteristics of the face remain constant relative to the encoded expression; map the encoded expression to a corresponding expression of a facial model; and generate the representation of the facial model based on the encoded expression.

In another example, a non-transitory computer-readable medium having stored thereon instructions is provided. The instructions, when executed by at least one processor, cause the at least one processor to: obtain one or more images of a face; generate an encoded expression representing an expression of the face, wherein predetermined characteristics of the face remain constant relative to the encoded expression; map the encoded expression to a corresponding expression of a facial model; and generate the representation of the facial model 15 based on the encoded expression.

As another example, an apparatus for generating a representation of a face is provided. The apparatus includes: means for obtaining one or more images of a face; means for generating an encoded expression representing an expression of the face, wherein predetermined characteristics of the face remain constant relative to the encoded expression; mapping the encoded expression to a corresponding expression of a facial model; and means for generating the representation of the facial model based on the encoded expression.

In another example, a method for training an expression encoder is provided. The method includes: obtaining a first frame and a second frame, the first frame and second frame including at least a portion of a face; generating a first expression feature for the first frame, the first expression feature representing a first expression of the face; generating a second expression feature for the second frame, the second expression feature representing a second expression of the face; generating a first view angle feature for the first frame, the first view angle feature representing a first angle from which the face is viewed from; generating a second view angle feature for the second frame, the second view angle feature representing a second angle from which the face is viewed from; crossing at least one of one of the first expression feature and second expression feature or the first view angle feature and the second view angle feature; determining a first loss value based on the crossing; and adjusting a feature encoder based on the determined first loss value.

As another example, an apparatus for training an expression encoder is provided. The apparatus includes: at least one memory; and at least one processor coupled to the at least one memory. The at least one processor being configured to: obtain a first frame and a second frame, the first frame and second frame including at least a portion of a face; generate a first expression feature for the first frame, the first expression feature representing a first expression of the face; generate a second expression feature for the second frame, the second expression feature representing a second expression of the face; generate a first view angle feature for the first frame, the first view angle feature representing a first angle from which the face is viewed from; generate a second view angle feature for the second frame, the second view angle feature representing a second angle from which the face is viewed from; cross at least one of one of the first expression feature and second expression feature or the first view angle feature and the second view angle feature; determine a first loss value based on the crossing; and adjust a feature encoder based on the determined first loss value.

In another example, a non-transitory computer-readable medium having stored thereon instructions is provided. The instructions, when executed by at least one processor, cause the at least one processor to: obtain a first frame and a second frame, the first frame and second frame including at least a portion of a face; generate a first expression feature for the first frame, the first expression feature representing a first expression of the face; generate a second expression feature for the second frame, the second expression feature representing a second expression of the face; generate a first view angle feature for the first frame, the first view angle feature representing a first angle from which the face is viewed from; generate a second view angle feature for the second frame, the second view angle feature representing a second angle from which the face is viewed from; cross at least one of one of the first expression feature and second expression feature or the first view angle feature and the second view angle feature; determine a first loss value based on the crossing; and adjust a feature encoder based on the determined first loss value.

As another example, an apparatus for training an expression encoder is provided. The apparatus includes: means for obtaining a first frame and a second frame, the first frame and second frame including at least a portion of a face; means for generating a first expression feature for the first frame, the first expression feature representing a first expression of the face; means for generating a second expression feature for the second frame, the second expression feature representing a second expression of the face; means for generating a first view angle feature for the first frame, the first view angle feature representing a first angle from which the face is viewed from; means for generating a second view angle feature for the second frame, the second view angle feature representing a second angle from which the face is viewed from; means for crossing at least one of one of the first expression feature and second expression feature or the first view angle feature and the second view angle feature; means for determining a first loss value based on the crossing; and means for adjusting a feature encoder based on the determined first loss value.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 illustrates an architecture for a machine learning model for avatar animation with general pretrained facial movement encoding, in accordance with aspects of the present disclosure.

FIG. 2 illustrates an overview of a training technique for a machine learning model for avatar animation with general pretrained facial movement encoding, in accordance with aspects of the present disclosure.

FIG. 3 illustrates a technique for encoder training to disentangle expression information from view angle information.

FIG. 4 illustrates an additional technique for encoder training to disentangle expression information from view angle information, in accordance with aspects of the present disclosure.

FIG. 5 illustrates a technique for encoder training to disentangle style information from expression information, in accordance with aspects of the present disclosure.

FIG. 6 is a flow diagram illustrating a process for animating a representation of a face, in accordance with aspects of the present disclosure.

FIG. 7 is a flow diagram illustrating a process for animating a representation of a face, in accordance with aspects of the present disclosure.

FIG. 8 is an illustrative example of a deep learning neural network that can be used by a 3D model training system.

FIG. 9 is an illustrative example of a convolutional neural network (CNN).

FIG. 10 is a diagram illustrating an example of a system for implementing certain aspects of the present technology.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The generation of three-dimensional (3D) models for physical objects can be useful for many systems and applications, such as for extended reality (XR) (e.g., including augmented reality (AR), virtual reality (VR), mixed reality (MR), etc.), robotics, automotive, aviation, 3D scene understanding, object grasping, object tracking, in addition to many other systems and applications. In AR environments, for example, a user may view images (also referred to as frames) that include an integration of artificial or virtual graphics with the user's natural surroundings. AR applications allow real images to be processed to add virtual objects to the images or to display virtual objects on a see-through display (so that the virtual objects appear to be overlaid over the real-world environment). AR applications can align or register the virtual objects to real-world objects (e.g., as observed in the images) in multiple dimensions. For instance, a real-world object that exists in reality can be represented using a model that resembles or is an exact match of the real-world object. In one example, a model of a virtual airplane representing a real airplane sitting on a runway may be presented by the display of an AR device (e.g., AR glasses, AR head-mounted display (HMD), or other device) while the user continues to view his or her natural surroundings through the display. The viewer may be able to manipulate the model while viewing the real-world scene. In another example, an actual object sitting on a table may be identified and rendered with a model that has a different color or different physical attributes in the AR environment. In some cases, artificial virtual objects that do not exist in reality or computer-generated copies of actual objects or structures of the user's natural surroundings can also be added to the AR environment.

There is an increasing number of applications that use face data (e.g., for XR systems, for 3D graphics, for security, among others), leading to a large demand for systems with the ability to generate detailed 3D face models (as well as 3D models of other objects) in an efficient and high-quality manner. There also exists a large demand for generating 3D models of other types of objects, such as 3D models of vehicles (e.g., for autonomous driving systems), 3D models of room layouts (e.g., for XR applications, for navigation by devices, robots, etc.), among others. Generating a detailed 3D model of an object (e.g., a 3D face model) typically requires expensive equipment and multiple cameras in an environment with controlled lighting, which hinders large-scale data collection.

Performing 3D facial animations (e.g., to animate a 3D model of an object, such as a face model) generally can be challenging and in many cases, state-of-the-art solutions for animating faces operate based on training process where a relatively large number of images are collected under various lighting conditions for a specific identity (e.g., specific user) is used to generate a latent code for the trained identity through analysis by synthesis. However, such systems may utilize a retraining process for different identities (e.g., different users), or may not be able to generalize well across image types (e.g., for images captured at different poses relative to a face). Rather, a technique to train a general encoder to exact facial expressions without being specific to (e.g., relying upon) identity, colorizing style, and/or viewing angle of images of the face.

Systems, apparatuses, electronic devices, methods (also referred to as processes), and computer-readable media (collectively referred to herein as “systems and techniques”) are described herein for avatar animation using a generate pretrained facial movement encoding. For example, a machine learning model with a pretrained visual encoder may be used to extract and encode facial expressions in a latent code, such as a vector during a pretrained stage. In some cases, the encoded facial expression may remain constant relative (e.g., be invariant) to predetermined characteristics of the face. For example, the encoded facial expression may be constant relative to different view angles, color styles, and/or identities (e.g., face invariant). This latent code may then be passed to a fine-tuning stage. The fine tuning stage may use the coded expression to animate a 3D model representation of a user (e.g., avatar). In some cases, the fine-tuning stage may include connected layers and a decoder which may be trained to generate and animate an avatar having a particular style or appearance. In some cases, audio information may also be used, for example, by the decoder, to animate the avatar. For example, the audio information may be used to make fine adjustments to a portion of the avatar, such as the lips.

In some cases, the visual encoder may include a motion feature extractor for extracting motion features from input images. The motion feature extractor may be trained to disentangle expression information from identity information, view angle information, and/or style information. In some cases, during training, a view feature extractor may be trained to identify view angle features and this view angle feature extractor used to disentangle view angle information (e.g., as provided by the view angle features) from the expression information using loss values. In some examples, style information may be disentangled based on loss values determined through comparisons between training images that have been augmented by altering color channels of the training image sand semantic labeled versions of the training image which have no color style information.

Various aspects of the application will be described with respect to the figures.

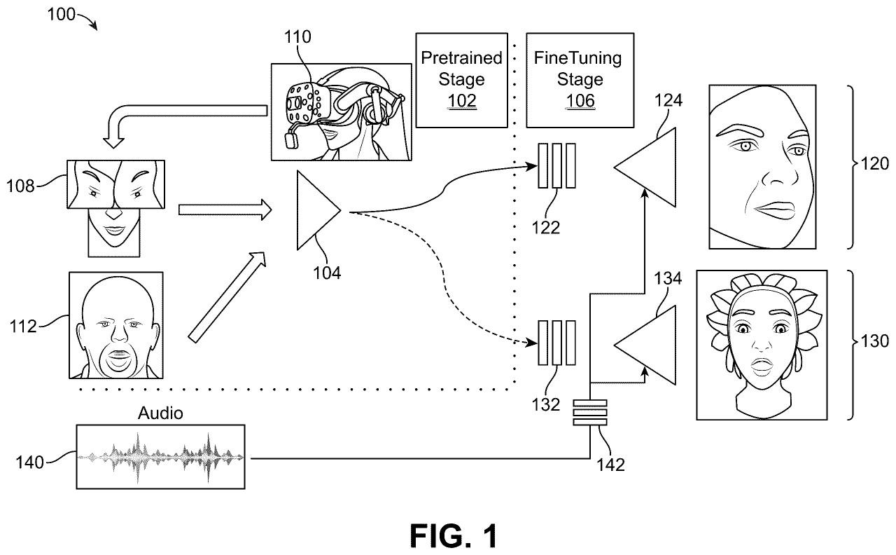

FIG. 1 illustrates an architecture for a machine learning model 100 for avatar animation with general pretrained facial movement encoding, in accordance with aspects of the present disclosure. As shown in FIG. 1, the machine learning model 100 may be divided into two general stages, the first stage 102 includes a pretrained visual encoder 104 to extract and encode facial expressions and the second stage 106 includes fine tuning to map the encoded facial expressions to representation of a user (e.g., an avatar). The visual encoder 104 may be pretrained to encode facial expressions based on motion and the visual encoder 104 may be invariant to predetermined characteristics. For example, the visual encoder may be independent (e.g., invariant) of an identity of a user, a view angle (e.g., angle from which an image of the user is captured), colorization style (e.g., color image, near infrared image, etc.), and the like. For example, the visual encoder 104 can receive images from different view angles of a face, (e.g., an angle from which the face is being viewed at or camera pose from which an image is captured from) such as image 108 captured by cameras mounted on a head mounted device (HMD) 110 or images 112 captured by a non-HMD device, such as a webcam, wireless device, etc., and for a given expression, the visual encoder 104 may generate the same latent code representing the expression. Additionally, for the expression, the visual encoder 104 may generate the same latent code representing the expression for multiple different people displaying the expression.

In some cases, the visual encoder 104 may encode the facial expression into a latent representation (e.g., latent code) of the facial expression as a smooth expression manifold, which may be fine-tuned for any number of down-stream applications, such as a first application 120 and a second application 130. In some cases, the expression manifold may be a distribution of sampling points in a latent space representing an expression, where each sampling point in the latent space representing an aspect of an expression. For example, the expression manifold may be a vector, such as a 256 dimension vector, where each dimension of the vector represents an aspect of the expression, Thus, varying entries of the dimensions may change the encoded expression. In some cases, the expression manifold may be smooth as the expression manifold allows for transitions between expression states. For example, when a user smiles, their mouth gradually forms into the smile over a period of time. The expression manifold may be sensitive enough (e.g., have sufficient dimensions and/or entry range for the dimensions) to be able to reflect this gradual transition from frame to frame over time. That is, the visual encoder 104 may be capable of mapping the gradual transition from frame to frame into a corresponding latent code (e.g., vector).

The second stage 106 may be performed by an application, such as a first application 120 and a second application 130, and the second stage 106 may include a set of fully connected layers 122, 132 coupled to a decoder 124, 134. In this example, the first application 120 includes a first fully connected layer 122 and a second decoder 124, while the second application 130 includes a second fully connected layer 132 and a second decoder 134. The fully connected layers 122, 132 may be a linear model to map the encoded expressions to corresponding expressions for an avatar, such as for a more realistic appearing first avatar 126, or a more stylized second avatar 136. For example, the fully connected layers 122, 132 may map an expression to distortions that may be applied to a 3D facial model to generate the expression. The decoders 124, 134 may generate the avatar based on the mapped expressions. For example, the decoders 124, 134 may obtain a 3D facial model and distort the 3D facial model based on the mapped expressions. In some cases, an audio signal 140 may be received and this received audio signal 140 may be used to enhance (e.g., improve) the expression generation. For example, the audio signal 140 may include sounds from the user (e.g., emitted by the face) represented by the avatar. The audio signal 140 may be passed to a fully connected layer 142, which may perform an affine transformation to help the decoders 124, 134 finetune the avatars, such as for fine adjustments of lip movement. That is, as visual features may be provided by the encoded expressions, movement of the mouth and/or lips may be primarily reconstructed based on the encoded expressions (which may help reconstructing silent mouth motions, such as smiling, frowning, etc.) and the audio signal 140 may help reconstruct fine motions of the mouth and/or lips during speech.

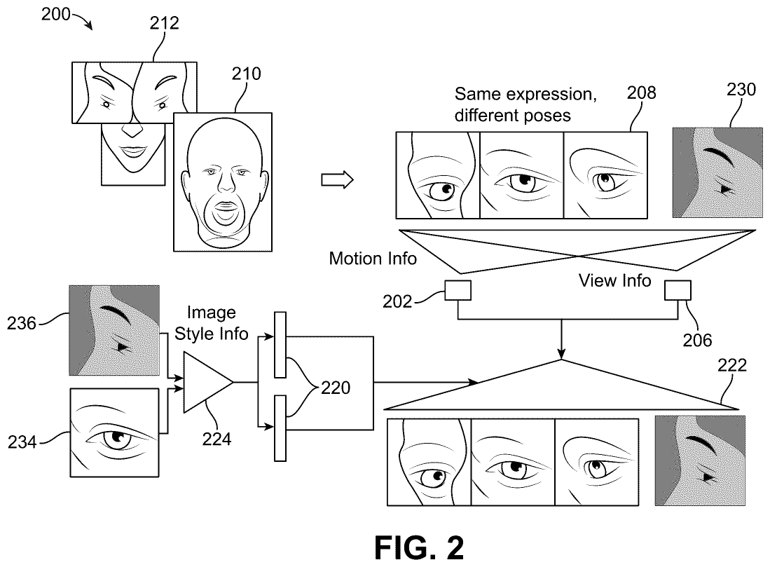

FIG. 2 illustrates an overview of a training technique 200 for a machine learning model for avatar animation with general pretrained facial movement encoding, in accordance with aspects of the present disclosure. As shown in FIG. 2, the technique 200 is based on three categories of information: motion information, view information, and style information. In some cases, a first encoder 202, such as encoder 104 of FIG. 1, may extract motion information of expressions on a face in received images. As discussed above, the first encoder 202 may be a motion feature extractor trained to be identity, view angle, and coloration style/image style invariant so that the first encoder 202 may extract the same motion (e.g., expression) features for images (e.g., training images 208, near infrared training images 230) of a same expression captured of different users from different views angles (e.g., angles, poses) and with different coloration styles (e.g., red/green/blue (RGB) color images 210, near infrared images 212, etc.). The extracted motions may be encoded as an expression of the face in the images. In some cases, to disentangle motion information from a particular view (e.g., viewing angle) and/or style, a view feature extractor 206 (e.g., encoder) may be used.

During training a view feature extractor 206 may be used to extract features of the view and these features may be used to help train the first encoder 202 to be independent of the angles (e.g., disentangle motion from view angle information), relative to the face, at which the images were captured at, and coloration styles of the images. In some cases, the view feature extractor 206 may be used to train the first encoder 202 via loss functions. In some cases, the view feature extractor 206 may not be used at inference (prediction) time and the view feature extractor may be discarded after the first encoder 202 is trained. The trained first encoder 202 may be used by any number of downstream applications, for example, to animate an avatar. For example, the same first encoder 202 may be used with any number of downstream applications.

As discussed above, a downstream application may include a set of fully connected layers 220 and a decoder 222. In some cases, the sets fully connected layers 220 may be trained by a second encoder 224 to encode image style information to animate an avatar. Encoding the style information may help allow style information to be added by the decoder 222, for example, to reproduce the training images 208 during the training process. In some cases, the training images with different color styles, such as RGB training image 234 and near infrared training image 236, may also be input to the second encoder 224 to train the sets of fully connected layers 220. As shown, different sets of fully connected layers 220 may be used for different domains.

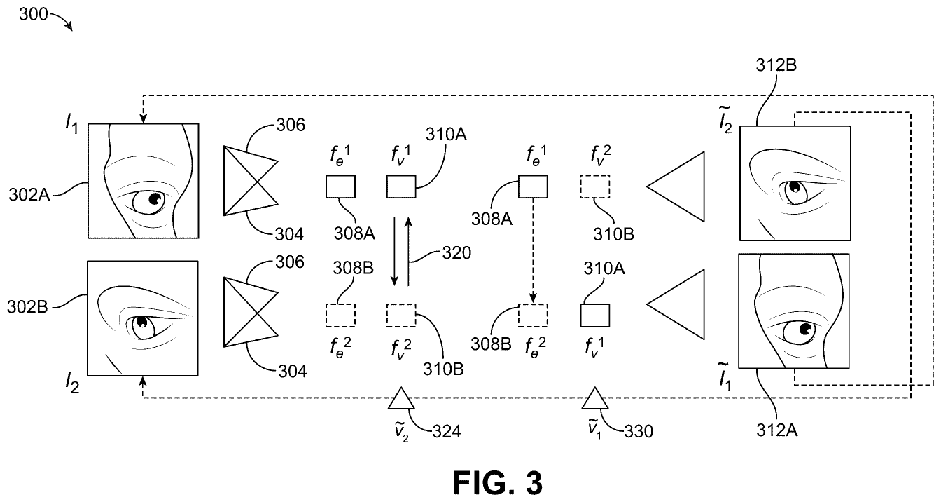

FIG. 3 illustrates a technique for encoder training 300 to disentangle expression information from view angle information. To help disentangle the view angle from the expression, it may be useful to use two encoders and cross combine the extracted features to disentangle expression based features from view angle based features. In some cases, loss values may be determined based on the cross combined attributes as well as comparisons of the extracted features. In some cases, weights of the encoders (e.g., expression encoder 304 and/or via angle encoder 306) may be adjusted based on the loss values as a part of encoder training.

As shown in FIG. 3, a first training image 302A and second training image 302B (collectively, training images 302) that show the same expression from two different angles may each be input to an expression encoder 304 (e.g., first encoder 202 of FIG. 2) and a view angle encoder 306 (e.g., view feature extractor 206 of FIG. 2). The expression encoder 304 may generate a first expression feature fₑ¹ 308A for the first training image 302A and a second expression feature fₑ² 308B for the second training image 302B. Similarly, the view angle encoder 306 may generate a first view angle feature fᵥ¹ 310A for the first training image 302A and a second view angle feature fᵥ² 310B for the second training image 302B. As the training images 302 show the same expression, the expression information may be constrained by the loss function. In some cases, the expression encoder 304 may be trained based on the expression loss Lₑ to help disentangle (e.g., isolate) the expression information from the view angle information, such that Lₑ=L₂(fₑ¹, fₑ²), and where the loss is a L₂ loss that pushes the values of the first expression feature fₑ¹ 308A and the values of the second expression feature fₑ² 308B together as the expression is the same.

In some cases, an expression cross loss L_{cross} may also be determined to help further disentangle the expression from the view angle. The expression cross loss L_{cross} may be obtained based on crossing 320 the first view angle feature fᵥ¹ 310A and the second view angle feature fᵥ² 310B and generating a first expression reconstructed image Ĩ₁ 312A and a second expression reconstructed image Ĩ₂ 312B. For example, the first view angle feature fᵥ¹ 310A associated with the first training image 302A may be crossed 320 with the second view angle feature fᵥ² 310B and using the second view angle feature fᵥ² 310B and first expression feature fₑ¹ 308A to reconstruct the second expression reconstructed image Ĩ₂ 312B. As the expression is assumed to be the same between the first training image 302A and second training image 302B, generating the second expression reconstructed image Ĩ₂ 312B using the first expression feature fₑ¹ 308A and the second view angle feature fᵥ² 310B should reconstruct the second training image 302B. Similarly, the for the second training image 302B, the second view angle feature fᵥ² 310B associated with the second training image 302B may be crossed 320 with the first view angle feature fᵥ¹ 310A and using the first view angle feature fᵥ¹ 310A and second expression feature fₑ² 308B (or the first expression feature fₑ¹ 308A) to reconstruct the first expression reconstructed image Ĩ₁ 312A. An image decoder D may be used to determine differences between a training image and a corresponding expression reconstructed image, such that Ĩ₁=D(fₑ², fᵥ¹) and Ĩ₂=D(fₑ¹, fᵥ²). The expression cross loss L_{cross} may then be expressed as L_{cross}=L₂(Ĩ₁, I₁)+L₂(Ĩ₂, I₂), where the L₂ loss helps push the expression reconstructed images toward the corresponding training image obtained from a different view angle.

In some cases, a view loss Lₚ may also be determined to help train the view angle encoder 306 learn to extract view angle features. The first view angle feature fᵥ¹ 310A should describe features of a first pose \tilde{v}₁ 330 of a camera used to capture the first training image 302A and the second view angle feature fᵥ² 310B should describe features of a second pose \tilde{v}₂ 332 of a camera used to capture the second training image 302B. A pose decoder D may be used to determine differences between a pose expressed in the view angle feature and the pose of the associated training image such that \tilde{v}₁=D(fᵥ¹) and \tilde{v}₂=D(fᵥ²). The view loss Lₚ may then be expressed as Lₚ=L₂(\tilde{v}₁, v₁)+L₂(\tilde{v}₂, v₂), where the L₂ loss helps push the pose expressed in the view angle feature towards the pose of a corresponding training image.

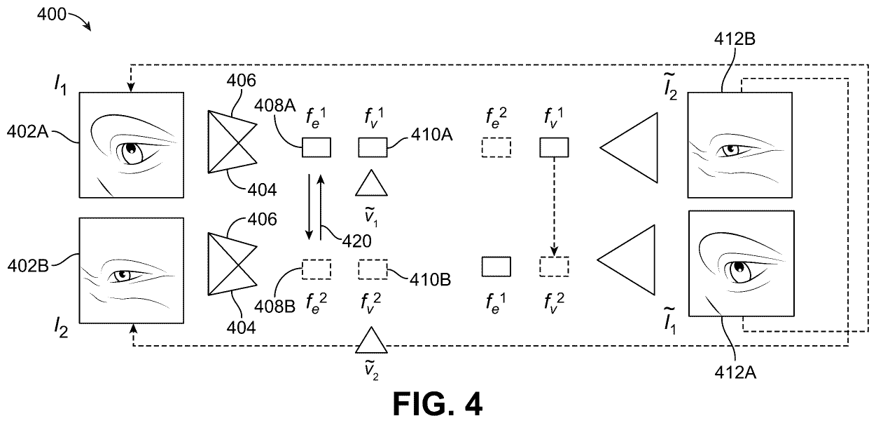

FIG. 4 illustrates an additional technique for encoder training 400 to disentangle expression information from view angle information, in accordance with aspects of the present disclosure. To help disentangle the view angle from the expression, it may be useful to train using multiple images obtained from the same viewing angle, but including multiple expressions. As shown in FIG. 3, a first training image 402A may be obtained at a certain viewing angle and contain a first expression. A second training image 402B may also be obtained at the same viewing angle and the second training image 402B may include a second, different, expression. An expression encoder 404 may generate a first expression feature fₑ¹ 408A representing the first expression in the first training image 402A and the expression encoder 404 may generate a second expression feature fₑ² 408B representing the second expression in the second training image 402B. Similarly, a view angle encoder 406 may generate a first view angle feature fᵥ¹ 410A for the first training image 402A and a second view angle feature fᵥ² 410B for the second training image 402B. As the first training image 402A and the second training image 402B have the same viewing angle, the viewing angle information may be constrained by the loss function. In some cases, the view angle encoder 306 may be trained based on a view angle loss Ly to help disentangle (e.g., isolate) the view angle information from the expression information, such that Lᵥ=L₂(fᵥ¹, fᵥ²), and where the loss is a L₂ loss that pushes the values of the first view angle feature fᵥ¹ 410A and the values of the second view angle feature fᵥ² 410B together as the view angle is the same.

In addition, a view angle cross loss \hat{L}cross may also be determined to help further disentangle the view angle from the expression. The view angle cross loss \hat{L}_{cross} may be obtained based on crossing 420 the first expression feature fₑ¹ 408A and the second expression feature fₑ² 408B and generating a first view angle reconstructed image Ĩ₁ 412A and a second expression reconstructed image Ĩ₂ 412B. For example, the first expression feature fₑ¹ 408A associated with the first training image 402A may be crossed 420 with the second expression feature fₑ² 408B. Using the second expression feature fₑ² 408B and the first view angle feature fᵥ¹ 410A, the second expression reconstructed image Ĩ₂ 412B may be reconstructed for comparison to the second training image 402B. Similarly, the first expression feature fₑ¹ 408A and the second view angle feature fᵥ² 410B may be used to reconstruct the first expression reconstructed image Ĩ₁ 412A for comparison to the first training image 402A. An image decoder D may be used to determine differences between a training image and a corresponding view angel reconstructed image, such that Ĩ₁=D(fₑ¹, fᵥ²) and Ĩ₂=D(fₑ², fᵥ¹). The expression cross loss \hat{L}_{cross} may then be expressed as \hat{L}_{cross}=L₂ (Ĩ₁, I₁)+L₂ (Ĩ₂, I₂), where the L₂ loss helps push the view angle reconstructed images toward the corresponding training image containing a different expression.

In some cases, a view loss \hat{L}ₚ may also be determined to help train the view angle encoder 306. For example, the first view angle feature fᵥ¹ 410A should describe features of a first pose \tilde{v}₁ 430 of a camera used to capture the first training image 402A and the second view angle feature fᵥ² 410B should describe features of a second pose \tilde{v}₂ 432 of a camera used to capture the second training image 402B. As the viewing angle as between the first training image 402A and second training image 402B is the same, the first view angle feature fᵥ¹ 410A and the second view angle feature fᵥ² 410B should be the same. A pose decoder D may be used to determine differences between a pose expressed in the view angle feature and the pose of the associated training image such that \tilde{v}₁=D(fᵥ¹) and \tilde{v}₂=D(fᵥ²). The view loss \hat{L}ₚ may then be expressed as \hat{L}ₚ=L₂ (\tilde{v}₁, v₁)+L₂ (\tilde{v}₂, v₂), where the L₂ loss helps push the pose expressed in the view angle feature towards the pose of a corresponding training image.

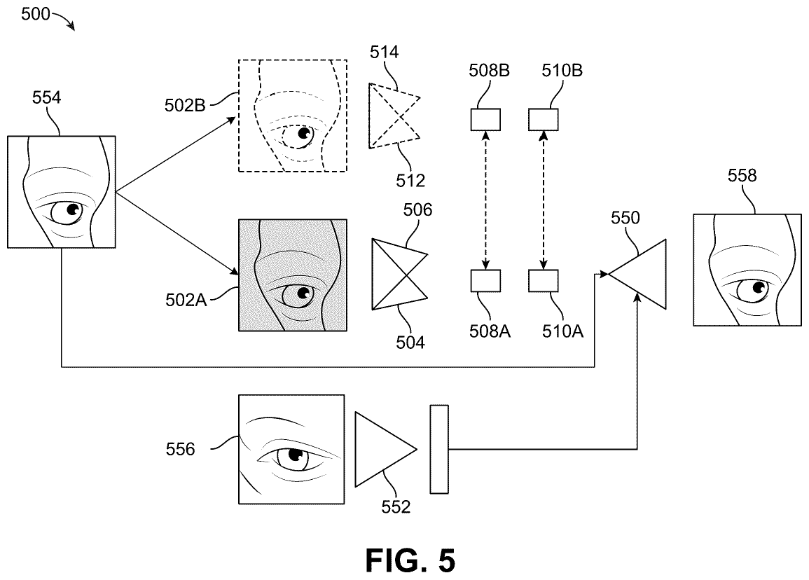

FIG. 5 illustrates a technique for encoder training 500 to disentangle style information from expression information, in accordance with aspects of the present disclosure. In some cases, style information may be information about a facial appearance independent of the expression and head pose. As examples, style information may be information about a skin tone, wrinkling appearance, varying appearances due to lighting changes or make-up. To help disentangle the expression and view angle information from colorizing style information (e.g., RGB, greyscale, near IR, etc.), the encoders may be trained by augmenting the training images. Augmenting the training images may be performed by altering the color channels of the training images to generate augmented training images, such as augmented training image 502. During training the augmented training image 502A may be passed to an expression encoder 504 (e.g., first encoder 202 of FIG. 2) and a view angle encoder 506 (e.g., view feature extractor 206 of FIG. 2) to generate an augmented expression feature fₑ^{A} 508A and an augmented view angle feature fᵥ⁴ 510A for the augmented training image 502A. In some cases, a surrogate expression encoder 512 and a surrogate view angle encoder 514 may be trained on semantic labeled versions of the training image 502B which have no color style information. Examples of semantic labeled versions of the training images may include sketches of the training images or segmented maps of the training images. Sketches of the training images may be based on edge maps extracted from the images or obtained using sketch style diffusion models. The surrogate expression encoder 512 may generate a surrogate expression feature fₑ^{S} 508B and the surrogate view angle encoder 514 may generate a surrogate view angle feature fᵥ^{S} 510B and expression. As the view angle and expression information of the augmented training image 502A and semantic labeled version of the training image 502B should be the same, the expression encoder 504 and view angle encoder 506 may be trained based on a style loss Lₛ, where Lₛ=L₂ (fₑ^{S}, fₑ^{A})+L₂ (fᵥ^{S}, fᵥ^{A}), where the loss is a L₂ loss that pushes the values of the augmented expression feature fₑ^{A} 508A surrogate expression feature fₑ^{S} 508B together and the values of the augmented view angle feature fᵥ^{A} 510A and surrogate view angle feature fᵥ^{S} 510B together.

In some cases, a decoder 550, such decoder 222 of FIG. 2 for a downstream application, may be trained to reproduce a latent style of images. For example, a style encoder 552 may be trained to extract latent style information from a reference style image 556 and used to train the decoder 550 to reproduce a training image 554 (I) as a reconstructed image 558 (I_{rec}) using the reference style from the reference style image 556 using the augmented expression feature fₑ^{A} 508A and augmented view angle feature fᵥ^{A} 510A. Of note, the decoder 222 may be style specific. In some cases, a loss for training the decoder may be a reconstruction loss (L_{rec}) as between the training image 554 and the reconstructed image 558, such that (L_{rec}=L₂ (I, I_{rec}).

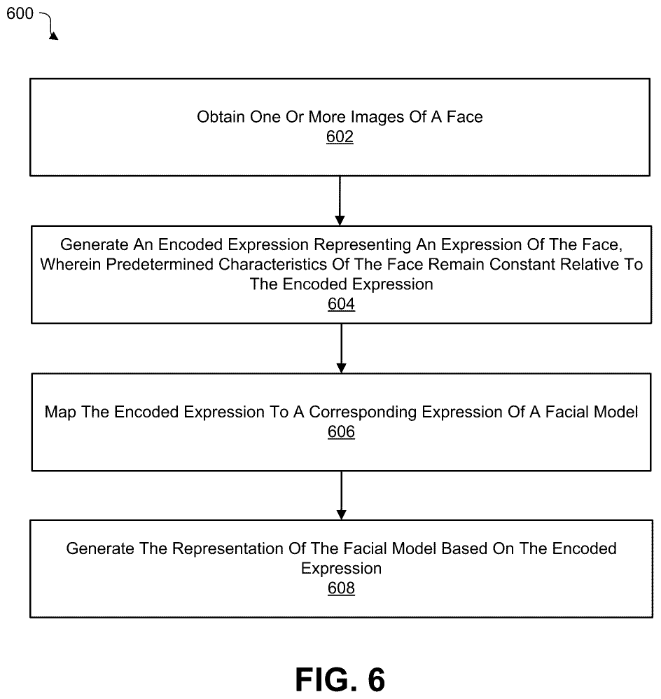

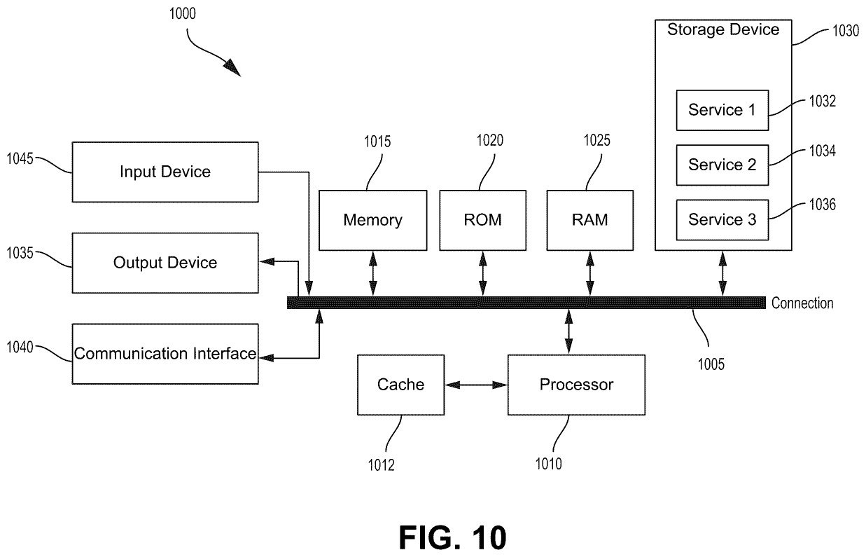

FIG. 6 is a flow diagram illustrating a process 600 for animating a representation of a face, in accordance with aspects of the present disclosure. The process 600 may be performed by a computing device (or apparatus) or a component (e.g., a chipset, codec, processor 1010 of FIG. 10, etc.) of the computing device. The computing device may be a mobile device (e.g., a mobile phone, and the like), a network-connected wearable such as a watch, an extended reality (XR) device such as a virtual reality (VR) device or augmented reality (AR) device, a vehicle or component or system of a vehicle, or other type of computing device (e.g., HMD 110 of FIG. 1, computing system 1000 of FIG. 10). The operations of the process 600 may be implemented as software components that are executed and run on one or more processors (e.g., processor 1010 of FIG. 10, and the like). In some cases, the operations of the process 600 can be implemented by a system having the computing system 1000 of FIG. 10.

At block 602, the computing device (or component thereof) may obtain one or more images or frames (e.g., images 108, images 112 of FIG. 1) of a face.

At block 604, the computing device (or component thereof) may generate an encoded expression (e.g., from visual encoder 104 of FIG. 4) representing an expression of the face. Predetermined characteristics of the face remain constant relative to the encoded expression. In some aspects, the computing device (or component thereof) may receive an image or a frame including at least a portion of a face. The computing device (or component thereof) can encode motion features of the frame into the encoded expression. The computing device (or component thereof) can output the encoded expression for transmission. In some cases, the encoded expression may be obtained from a pretrained visual encoder (e.g., expression encoder). In some cases, the encoded expression is based on motion features determined based on images of the face. In some examples, the predetermined characteristics of the face include at least one of a view angle, color style, or identity of the face.

At block 606, the computing device (or component thereof) may map the encoded expression to a corresponding expression of a facial model. For example, the fully connected layers, such as fully connected layers 122, 132 of FIG. 2, may map an expression to distortions that may be applied to a 3D facial model to generate the expression.

At block 608, the computing device (or component thereof) may generate the representation of the facial model based on the encoded expression. For example, the decoders, such as decoders 124, 134 of FIG. 1, may obtain a 3D facial model and distort the 3D facial model based on the mapped expressions. In some cases, the generating of the representation of the facial model is enhanced based on an audio signal (e.g., audio signal 140 of FIG. 1) obtained concurrently with the one or more images of the face.

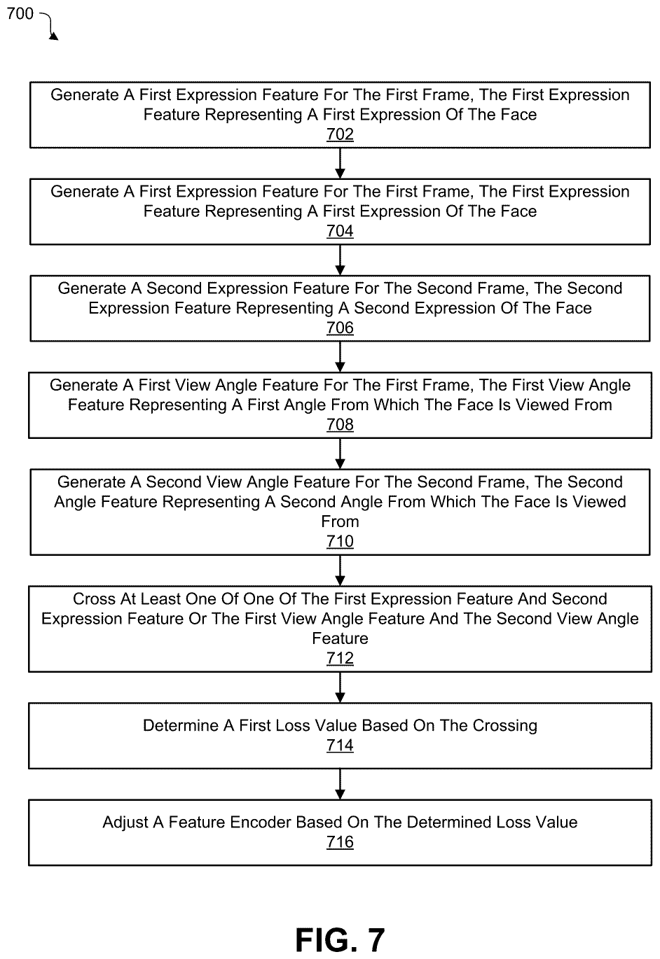

FIG. 7 is a flow diagram illustrating a process 700 for animating a representation of a face, in accordance with aspects of the present disclosure. The process 700 may be performed by a computing device (or apparatus) or a component (e.g., a chipset, codec, processor 1010 of FIG. 10, etc.) of the computing device. The computing device may be a mobile device (e.g., a mobile phone, and the like), a network-connected wearable such as a watch, an extended reality (XR) device such as a virtual reality (VR) device or augmented reality (AR) device, a vehicle or component or system of a vehicle, or other type of computing device (e.g., HMD 110 of FIG. 1, computing system 1000 of FIG. 10). The operations of the process 700 may be implemented as software components that are executed and run on one or more processors (e.g., processor 1010 of FIG. 10, and the like). In some cases, the operations of the process 700 can be implemented by a system having the architecture 1000 of FIG. 10.

At block 702, the computing device (or component thereof) may obtain a first frame and a second frame (e.g., images 108, images 112 of FIG. 1, color images 210, near infrared images 212 of FIG. 2, training images 302 of FIG. 3, training images 402 of FIG. 4, training image 554 of FIG. 5, etc.), the first frame and second frame including at least a portion of a face.

At block 704, the computing device (or component thereof) may generate a first expression feature (e.g., first expression feature fₑ¹ 308A of FIG. 3, first expression feature fₑ¹ 408A of FIG. 4) for the first frame (e.g., by encoder 104 of FIG. 1, first encoder 202 of FIG. 2, expression encoder 304 of FIG. 3, expression encoder 404 of FIG. 4 etc.), the first expression feature representing a first expression of the face.

At block 706, the computing device (or component thereof) may generate a second expression feature (e.g., second expression feature fₑ² 308B of FIG. 3, second expression feature fₑ² 408B of FIG. 4, etc.) for the second frame, the second expression feature representing a second expression of the face.

At block 708, the computing device (or component thereof) may generate a first view angle feature (e.g., first view angle feature fᵥ¹ 310A, first view angle feature fᵥ¹ 410A of FIG. 4, etc.) for the first frame (e.g., by view feature extractor 206 of FIG. 2, angle encoder 306 of FIG. 3, view angle encoder 406 of FIG. 4, etc.), the first view angle feature representing a first angle from which the face is viewed.

At block 710, the computing device (or component thereof) may generate a second view angle feature (e.g., second view angle feature fᵥ² 310B of FIG. 3, second view angle feature fᵥ² 410B of FIG. 4, etc.) for the second frame, the second view angle feature representing a second angle from which the face is viewed from.

At block 712, the computing device (or component thereof) may cross at least one of one of the first expression feature and second expression feature or the first view angle feature and the second view angle feature (e.g., crossing 320 of FIG. 3, crossing 420 of FIG. 4, etc.). In some cases, the first expression matches the second expression, and the first view angle feature is crossed with the second view angle feature. In such cases, the computing device (or component thereof) may generate a first reconstructed image (e.g., first expression reconstructed image Ĩ₁ 312A of FIG. 3) based on the crossed first view angle feature; generate a second reconstructed image (e.g., second expression reconstructed image Ĩ₂ 312B) based on the crossed second view angle feature; determine the first loss value based on a comparison between the first reconstructed image and the first frame; and determine a second loss value (e.g., expression cross loss Îcross) based on a comparison between the second reconstructed image and the second frame. In some examples, the computing device (or component thereof) may determine a third loss value (e.g., view loss Lₚ) based on the first expression feature and the second expression feature. In some cases, the first angle matches the second angle, and wherein the first expression feature is crossed with the second expression feature. In such cases, the computing device (or component thereof) may generate a first reconstructed image (e.g., 412A of FIG. 4) based on the crossed first expression feature; generate a second reconstructed image (e.g., 412B of FIG. 4) based on the crossed second expression feature; determine the first loss value based on a comparison between the first reconstructed image and the first frame; and determine a second loss value (e.g., expression cross loss \hat{L}_{cross}) based on a comparison between the second reconstructed image and the second frame. In some examples, the computing device (or component thereof) may determine a third loss value (e.g., view loss \hat{L}ₚ) based on the first view angle feature and the second view angle feature

At block 714, the computing device (or component thereof) may determine a first loss value (e.g., expression loss Lₑ, expression cross loss L_{cross}, view angle cross loss \hat{L}_{cross}, view angle loss Lᵥ, view loss \hat{L}ₚ, etc.) based on the crossing. In some cases, the computing device (or component thereof) may augment the first frame to generate an augmented frame (e.g., augmented training image 502 of FIG. 5); generate an augmented expression feature (e.g., augmented expression feature fₑ^{A} 508A of FIG. 5) based on the augmented frame; generate an augmented view angle feature (e.g., augmented view angle feature fᵥ^{A} 510A of FIG. 5) based on the augmented frame; obtain a semantic labelled version of the first frame (e.g., semantic labeled versions of the training image 502B of FIG. 5); generate a surrogate expression feature (e.g., surrogate expression feature fₑ^{S} 508B of FIG. 5) based on the semantically labelled version of the first frame; generate a surrogate view angle feature (e.g., surrogate view angle feature fᵥ^{S} 510B of FIG. 5) based on the semantically labelled version of the first frame; and generate a third loss value (e.g., style loss Lₛ) based on a comparison between the augmented expression feature and the surrogate expression feature and a comparison between augmented view angle feature and the surrogate view angle feature. In some examples, the computing device (or component thereof) may augment the first frame by adjusting color channels of the first frame.

At block 716, the computing device (or component thereof) may adjust a feature encoder (e.g., by encoder 104 of FIG. 1, first encoder 202 of FIG. 2, view feature extractor 206 of FIG. 2, expression encoder 304 of FIG. 3, angle encoder 306 of FIG. 3, expression encoder 404 of FIG. 4, view angle encoder 406 of FIG. 4, etc.) based on the determined first loss value.

The computing device can include any suitable device, such as a mobile device (e.g., a mobile phone), a desktop computing device, a tablet computing device, an extended reality (XR) device or system (e.g., a VR headset, an AR headset, AR glasses, or other XR device or system), a wearable device (e.g., a network-connected watch or smartwatch, or other wearable device), a server computer or system, a vehicle or computing device of a vehicle (e.g., an autonomous vehicle), a robotic device, a television, and/or any other computing device with the resource capabilities to perform the processes described herein, including the process 600. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes 600, 700 are illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes 600, 700 and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

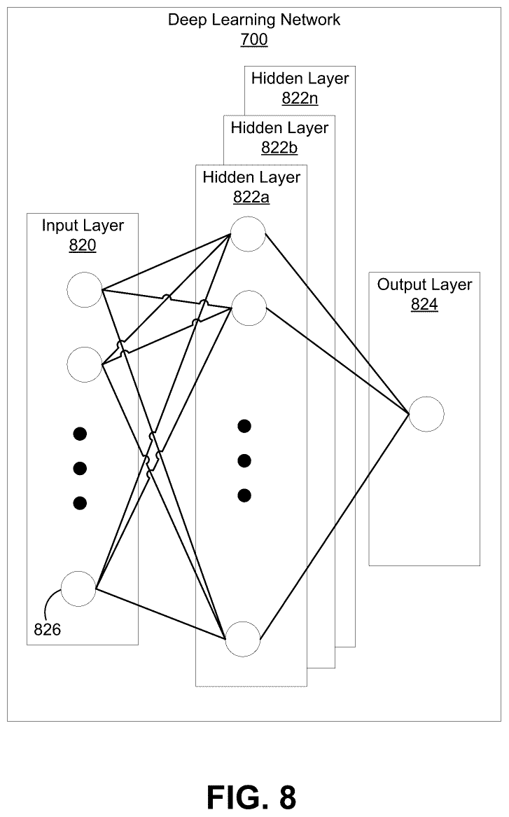

FIG. 8 is an illustrative example of a deep learning neural network 800 that can be used by a 3D model training system. An input layer 820 includes input data. In one illustrative example, the input layer 820 can include data representing the pixels of an input video frame. The neural network 800 includes multiple hidden layers 822a, 822b, through 822n. The hidden layers 822a, 822b, through 822n include “n” number of hidden layers, where “n” is an integer greater than or equal to one. The number of hidden layers can be made to include as many layers as needed for the given application. The neural network 800 further includes an output layer 824 that provides an output resulting from the processing performed by the hidden layers 822a, 822b, through 822n. In one illustrative example, the output layer 824 can provide a classification for an object in an input video frame. The classification can include a class identifying the type of object (e.g., a person, a dog, a cat, or other object).

The neural network 800 is a multi-layer neural network of interconnected nodes. Each node can represent a piece of information. Information associated with the nodes is shared among the different layers and each layer retains information as information is processed. In some cases, the neural network 800 can include a feed-forward network, in which case there are no feedback connections where outputs of the network are fed back into itself. In some cases, the neural network 800 can include a recurrent neural network, which can have loops that allow information to be carried across nodes while reading in input.

Information can be exchanged between nodes through node-to-node interconnections between the various layers. Nodes of the input layer 820 can activate a set of nodes in the first hidden layer 822a. For example, as shown, each of the input nodes of the input layer 820 is connected to each of the nodes of the first hidden layer 822a. The nodes of the hidden layers 822a, 822b, through 822n can transform the information of each input node by applying activation functions to the information. The information derived from the transformation can then be passed to and can activate the nodes of the next hidden layer 822b, which can perform their own designated functions. Example functions include convolutional, up-sampling, data transformation, and/or any other suitable functions. The output of the hidden layer 822b can then activate nodes of the next hidden layer, and so on. The output of the last hidden layer 822n can activate one or more nodes of the output layer 824, at which an output is provided. In some cases, while nodes (e.g., node 826) in the neural network 800 are shown as having multiple output lines, a node has a single output and all lines shown as being output from a node represent the same output value.

In some cases, each node or interconnection between nodes can have a weight that is a set of parameters derived from the training of the neural network 800. Once the neural network 800 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 800 to be adaptive to inputs and able to learn as more and more data is processed.

The neural network 800 is pre-trained to process the features from the data in the input layer 820 using the different hidden layers 822a, 822b, through 822n in order to provide the output through the output layer 824. In an example in which the neural network 800 is used to identify objects in images, the neural network 800 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [001000000 0].

In some cases, the neural network 800 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 800 is trained well enough so that the weights of the layers are accurately tuned.

For the example of identifying objects in images, the forward pass can include passing a training image through the neural network 800. The weights are initially randomized before the neural network 800 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 800, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 800 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 800 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wi denotes the initial weight, and n denotes a learning rate. The learning rate can be set to any suitable value, with a high learning rate including larger weight updates and a lower value indicating smaller weight updates.

The neural network 800 can include any suitable deep network. One example includes a convolutional neural network (CNN), which includes an input layer and an output layer, with multiple hidden layers between the input and out layers. An example of a CNN is described below with respect to FIG. 8. The hidden layers of a CNN include a series of convolutional, nonlinear, pooling (for downsampling), and fully connected layers. The neural network 800 can include any other deep network other than a CNN, such as an autoencoder, a deep belief nets (DBNs), a Recurrent Neural Networks (RNNs), among others.

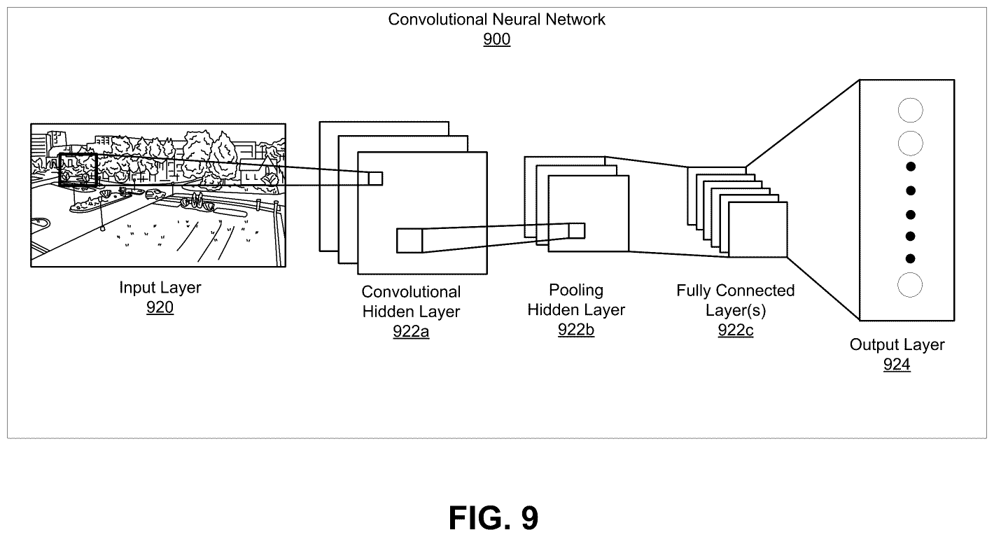

FIG. 9 is an illustrative example of a convolutional neural network 900 (CNN 900). The input layer 920 of the CNN 900 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 922a, an optional non-linear activation layer, a pooling hidden layer 922b, and fully connected hidden layers 922c to get an output at the output layer 924. While only one of each hidden layer is shown in FIG. 9, one of ordinary skill will appreciate that multiple convolutional hidden layers, non-linear layers, pooling hidden layers, and/or fully connected layers can be included in the CNN 900. As previously described, the output can indicate a single class of an object or can include a probability of classes that best describe the object in the image.

The first layer of the CNN 900 is the convolutional hidden layer 922a. The convolutional hidden layer 922a analyzes the image data of the input layer 920. Each node of the convolutional hidden layer 922a is connected to a region of nodes (pixels) of the input image called a receptive field. The convolutional hidden layer 922a can be considered as one or more filters (each filter corresponding to a different activation or feature map), with each convolutional iteration of a filter being a node or neuron of the convolutional hidden layer 922a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 922a. Each connection between a node and a receptive field for that node learns a weight and, in some cases, an overall bias such that each node learns to analyze its particular local receptive field in the input image. Each node of the hidden layer 922a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 922a is due to each node of the convolutional layer being applied to its corresponding receptive field. For example, a filter of the convolutional hidden layer 922a can begin in the top-left corner of the input image array and can convolve around the input image. As noted above, each convolutional iteration of the filter can be considered a node or neuron of the convolutional hidden layer 922a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 922a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 922a.

The mapping from the input layer to the convolutional hidden layer 922a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 922a can include several activation maps in order to identify multiple features in an image. The example shown in FIG. 9 includes three activation maps. Using three activation maps, the convolutional hidden layer 922a can detect three different kinds of features, with each feature being detectable across the entire image.

In some examples, a non-linear hidden layer can be applied after the convolutional hidden layer 922a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 900 without affecting the receptive fields of the convolutional hidden layer 922a.

The pooling hidden layer 922b can be applied after the convolutional hidden layer 922a (and after the non-linear hidden layer when used). The pooling hidden layer 922b is used to simplify the information in the output from the convolutional hidden layer 922a. For example, the pooling hidden layer 922b can take each activation map output from the convolutional hidden layer 922a and generates a condensed activation map (or feature map) using a pooling function. Max-pooling is one example of a function performed by a pooling hidden layer. Other forms of pooling functions be used by the pooling hidden layer 922a, such as average pooling, L2-norm pooling, or other suitable pooling functions. A pooling function (e.g., a max-pooling filter, an L2-norm filter, or other suitable pooling filter) is applied to each activation map included in the convolutional hidden layer 922a. In the example shown in FIG. 9, three pooling filters are used for the three activation maps in the convolutional hidden layer 922a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 922a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 922a having a dimension of 24×24 nodes, the output from the pooling hidden layer 922b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 900.

The final layer of connections in the network is a fully-connected layer that connects every node from the pooling hidden layer 922b to every one of the output nodes in the output layer 924. Using the example above, the input layer includes 28×28 nodes encoding the pixel intensities of the input image, the convolutional hidden layer 922a includes 3×24×24 hidden feature nodes based on application of a 5×5 local receptive field (for the filters) to three activation maps, and the pooling layer 922b includes a layer of 3×12×12 hidden feature nodes based on application of max-pooling filter to 2×2 regions across each of the three feature maps. Extending this example, the output layer 924 can include ten output nodes. In such an example, every node of the 3×12×12 pooling hidden layer 922b is connected to every node of the output layer 924.

The fully connected layer 922c can obtain the output of the previous pooling layer 922b (which should represent the activation maps of high-level features) and determines the features that most correlate to a particular class. For example, the fully connected layer 922c layer can determine the high-level features that most strongly correlate to a particular class, and can include weights (nodes) for the high-level features. A product can be computed between the weights of the fully connected layer 922c and the pooling hidden layer 922b to obtain probabilities for the different classes. For example, if the CNN 900 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 924 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 10 is a diagram illustrating an example of a system for implementing certain aspects of the present technology. In particular, FIG. 10 illustrates an example of computing system 1000, which can be for example any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1000 includes at least one processing unit (CPU or processor) 1010 and connection 1005 that couples various system components including system memory 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000. Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some aspects, a hardware service that performs a particular function can include the software component stored in a computer-readable medium in connection with the necessary hardware components, such as processor 1010, connection 1005, output device 1035, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, mobile phones (e.g., smartphones or other types of mobile phones), tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the present disclosure include:

Aspect 1. A method for generating a representation of a face, the method comprising: obtaining one or more images of a face; generating an encoded expression representing an expression of the face, wherein predetermined characteristics of the face remain constant relative to the encoded expression; mapping the encoded expression to a corresponding expression of a facial model; and generating the representation of the facial model based on the encoded expression.

Aspect 2. The method of Aspect 1, wherein the encoded expression is based on motion features determined based on images of the face.

Aspect 3. The method of any of Aspects 1-2, wherein the predetermined characteristics of the face include at least one of a view angle, color style, or identity of the face.

Aspect 4. The method of any of Aspects 1-4, wherein the generating of the representation of the facial model is enhanced based on an audio signal obtained concurrently with the one or more images of the face.

Aspect 5. The method of any of Aspects 1-4, further comprising: receiving a frame, the frame including at least a portion of a face; encoding motion features of the frame into the encoded expression; and outputting the encoded expression for transmission.

Aspect 6. A method for training an expression encoder, comprising: obtaining a first frame and a second frame, the first frame and second frame including at least a portion of a face; generating a first expression feature for the first frame, the first expression feature representing a first expression of the face; generating a second expression feature for the second frame, the second expression feature representing a second expression of the face; generating a first view angle feature for the first frame, the first view angle feature representing a first angle from which the face is viewed from; generating a second view angle feature for the second frame, the second view angle feature representing a second angle from which the face is viewed from; crossing at least one of one of the first expression feature and second expression feature or the first view angle feature and the second view angle feature; determining a first loss value based on the crossing; and adjusting a feature encoder based on the determined first loss value.

Aspect 7. The method of Aspect 6, wherein the first expression matches the second expression, and wherein the first view angle feature is crossed with the second view angle feature, and further comprising: generating a first reconstructed image based on the crossed first view angle feature; generating a second reconstructed image based on the crossed second view angle feature; determining the first loss value based on a comparison between the first reconstructed image and the first frame; and determining a second loss value based on a comparison between the second reconstructed image and the second frame.

Aspect 8. The method of Aspect 7, further comprising determining a third loss value based on the first expression feature and the second expression feature.

Aspect 9. The method of any of Aspects 6-8, wherein the first angle matches the second angle, and wherein the first expression feature is crossed with the second expression feature, and further comprising: generating a first reconstructed image based on the crossed first expression feature; generating a second reconstructed image based on the crossed second expression feature; determining the first loss value based on a comparison between the first reconstructed image and the first frame; and determining a second loss value based on a comparison between the second reconstructed image and the second frame.

Aspect 10. The method of Aspect 9, further comprising determining a third loss value based on the first view angle feature and the second view angle feature.

Aspect 11. The method of any of Aspects 6-10, further comprising: augmenting the first frame to generate an augmented frame; generating an augmented expression feature based on the augmented frame; generating an augmented view angle feature based on the augmented frame; obtaining a semantic labelled version of the first frame; generating a surrogate expression feature based on the semantically labelled version of the first frame; generating a surrogate view angle feature based on the semantically labelled version of the first frame; and generating a third loss value based on a comparison between the augmented expression feature and the surrogate expression feature and a comparison between augmented view angle feature and the surrogate view angle feature.

Aspect 12. The method of Aspect 11, wherein augmenting the first frame comprises adjusting color channels of the first frame.

Aspect 13. An apparatus for generating a representation of a face, the apparatus comprising: at least one memory; and at least one processor coupled to the at least one memory, the at least one processor being configured to: obtain one or more images of a face; generate an encoded expression representing an expression of the face, wherein predetermined characteristics of the face remain constant relative to the encoded expression; map the encoded expression to a corresponding expression of a facial model; and generate the representation of the facial model based on the encoded expression.

Aspect 14. The apparatus of Aspect 13, wherein the encoded expression is based on motion features determined based on images of the face.

Aspect 15. The apparatus of any of Aspects 13-14, wherein the predetermined characteristics of the face include at least one of a view angle, color style, or identity of the face.

Aspect 16. The apparatus of any of Aspects 13-15, wherein the generating of the representation of the facial model is enhanced based on an audio signal obtained concurrently with the one or more images of the face.

Aspect 17. The apparatus of any of Aspects 13-16, wherein the processor is further configured to: receive a frame, the frame including at least a portion of a face; encode motion features of the frame into the encoded expression; and output the encoded expression for transmission.

Aspect 18. An apparatus for training an expression encoder, the apparatus comprising: at least one memory; and at least one processor coupled to the at least one memory, the at least one processor being configured to: obtain a first frame and a second frame, the first frame and second frame including at least a portion of a face; generate a first expression feature for the first frame, the first expression feature representing a first expression of the face; generate a second expression feature for the second frame, the second expression feature representing a second expression of the face; generate a first view angle feature for the first frame, the first view angle feature representing a first angle from which the face is viewed from; generate a second view angle feature for the second frame, the second view angle feature representing a second angle from which the face is viewed from; cross at least one of one of the first expression feature and second expression feature or the first view angle feature and the second view angle feature; determine a first loss value based on the crossing; and adjust a feature encoder based on the determined first loss value.

Aspect 19. The apparatus of Aspect 18, wherein the first expression matches the second expression, and wherein the first view angle feature is crossed with the second view angle feature, and further comprising: generate a first reconstructed image based on the crossed first view angle feature; generate a second reconstructed image based on the crossed second view angle feature; determine the first loss value based on a comparison between the first reconstructed image and the first frame; and determine a second loss value based on a comparison between the second reconstructed image and the second frame.

Aspect 20. The apparatus of Aspect 19, wherein the at least one processor is further configured to determine a third loss value based on the first expression feature and the second expression feature.

Aspect 21. The apparatus of any of Aspects 18-20, wherein the first angle matches the second angle, and wherein the first expression feature is crossed with the second expression feature, and wherein the at least one processor is further configured to: generate a first reconstructed image based on the crossed first expression feature; generate a second reconstructed image based on the crossed second expression feature; determine the first loss value based on a comparison between the first reconstructed image and the first frame; and determine a second loss value based on a comparison between the second reconstructed image and the second frame.

Aspect 22. The apparatus of Aspect 21, wherein the at least one processor is further configured to determine a third loss value based on the first view angle feature and the second view angle feature.

Aspect 23. The apparatus of any of Aspects 18-22, wherein the at least one processor is further configured to: augment the first frame to generate an augmented frame; generate an augmented expression feature based on the augmented frame; generate an augmented view angle feature based on the augmented frame; obtain a semantic labelled version of the first frame; generate a surrogate expression feature based on the semantically labelled version of the first frame; generate a surrogate view angle feature based on the semantically labelled version of the first frame; and generate a third loss value based on a comparison between the augmented expression feature and the surrogate expression feature and a comparison between augmented view angle feature and the surrogate view angle feature.

Aspect 24. The apparatus of Aspect 23, wherein, to augment the first frame, the at least one processor is configured to adjust color channels of the first frame.

Aspect 25. A non-transitory computer-readable medium having stored thereon instructions that, when executed by at least one processor, cause the at least one processor to: obtain one or more images of a face; obtain one or more images of a face; generate an encoded expression representing an expression of the face, wherein predetermined characteristics of the face remain constant relative to the encoded expression; map the encoded expression to a corresponding expression of a facial model; and generate a representation of the facial model based on the encoded expression.

Aspect 26. The non-transitory computer-readable medium of Aspect 25, wherein the encoded expression is based on motion features determined based on images of the face.

Aspect 27. The non-transitory computer-readable medium of any of Aspects 25-26, wherein the predetermined characteristics of the face include at least one of a view angle, color style, or identity of the face.

Aspect 28. The non-transitory computer-readable medium of any of Aspects 25-26, wherein the generating of the representation of the face from the one or more images is enhanced based on an audio signal obtained concurrently with the one or more images of the face.

Aspect 29. The non-transitory computer-readable medium of any of Aspects 25-26, wherein the instructions further cause the at least one processor to: receive a frame, the frame including at least a portion of a face; encode motion features of the frame into the encoded expression, wherein the encoded expression is face and view angle invariant; and output the encoded expression for transmission.

Aspect 30. A non-transitory computer-readable medium having stored thereon instructions that, when executed by at least one processor, cause the at least one processor to: obtain a first frame and a second frame, the first frame and second frame including at least a portion of a face; generate a first expression feature for the first frame, the first expression feature representing a first expression of the face; generate a second expression feature for the second frame, the second expression feature representing a second expression of the face; generate a first view angle feature for the first frame, the first view angle feature representing a first angle from which the face is viewed from; generate a second view angle feature for the second frame, the second view angle feature representing a second angle from which the face is viewed from; cross at least one of one of the first expression feature and second expression feature or the first view angle feature and the second view angle feature; determine a first loss value based on the crossing; and adjust a feature encoder based on the determined first loss value.

Aspect 31. The non-transitory computer-readable medium of Aspect 30, wherein the first expression matches the second expression, and wherein the first view angle feature is crossed with the second view angle feature, and further comprising: generate a first reconstructed image based on the crossed first view angle feature; generate a second reconstructed image based on the crossed second view angle feature; determine the first loss value based on a comparison between the first reconstructed image and the first frame; and determine a second loss value based on a comparison between the second reconstructed image and the second frame.

Aspect 32. The non-transitory computer-readable medium of Aspect 31, wherein the instructions cause the at least one processor to determine a third loss value based on the first expression feature and the second expression feature.

Aspect 33. The non-transitory computer-readable medium of any of Aspects 30-32, wherein the first angle matches the second angle, and wherein the first expression feature is crossed with the second expression feature, and wherein the instructions cause the at least one processor to: generate a first reconstructed image based on the crossed first expression feature; generate a second reconstructed image based on the crossed second expression feature; determine the first loss value based on a comparison between the first reconstructed image and the first frame; and determine a second loss value based on a comparison between the second reconstructed image and the second frame.

Aspect 34. The non-transitory computer-readable medium of Aspect 33, wherein the instructions cause the at least one processor to determine a third loss value based on the first view angle feature and the second view angle feature.

Aspect 35. The non-transitory computer-readable medium of any of Aspects 30-34, wherein the instructions cause the at least one processor to: augment the first frame to generate an augmented frame; generate an augmented expression feature based on the augmented frame; generate an augmented view angle feature based on the augmented frame; obtain a semantic labelled version of the first frame; generate a surrogate expression feature based on the semantically labelled version of the first frame; generate a surrogate view angle feature based on the semantically labelled version of the first frame; and generate a third loss value based on a comparison between the augmented expression feature and the surrogate expression feature and a comparison between augmented view angle feature and the surrogate view angle feature.

Aspect 36. The non-transitory computer-readable medium of Aspect 35, wherein, to augment the first frame, the instructions cause the at least one processor to adjust color channels of the first frame.

Aspect 37. An apparatus for generating a representation of a face comprising one or more means for performing operations according to any of Aspects 1-5.

Aspect 38. An apparatus for training an expression encoder comprising one or more means for performing operations according to any of Aspects 6-12.

Aspect 39. A method for generating a representation of a face, the method comprising: obtaining an encoded expression representing an expression of the face, wherein predetermined characteristics of the face remain constant relative to the encoded expression; mapping the encoded expression to a corresponding expression of a facial model; and generating the representation of the facial model based on the encoded expression.

Aspect 40: An apparatus for generating a representation of a face, the apparatus comprising: at least one memory; and at least one processor coupled to the at least one memory, the at least one processor being configured to: obtain an encoded expression representing an expression of the face, wherein predetermined characteristics of the face remain constant relative to the encoded expression; map the encoded expression to a corresponding expression of a facial model; and generate the representation of the facial model based on the encoded expression.

Aspect 41: A non-transitory computer-readable medium having stored thereon instructions that, when executed by at least one processor, cause the at least one processor to: obtain an encoded expression representing an expression of the face, wherein predetermined characteristics of the face remain constant relative to the encoded expression; map the encoded expression to a corresponding expression of a facial model; and generate a representation of the facial model based on the encoded expression.

What is claimed is:

1. A method for generating a representation of a face, the method comprising:
obtaining one or more images of a face;
generating an encoded expression representing an expression of the face, wherein predetermined characteristics of the face remain constant relative to the encoded expression;
mapping the encoded expression to a corresponding expression of a facial model; and
generating the representation of the facial model based on the encoded expression.

2. The method of claim 1, wherein the encoded expression is based on motion features determined based on images of the face.

3. The method of claim 1, wherein the predetermined characteristics of the face include at least one of a view angle, color style, or identity of the face.

4. The method of claim 1, wherein the generating of the representation of the facial model is enhanced based on an audio signal obtained concurrently with the one or more images of the face.

5. The method of claim 1, further comprising:
receiving a frame, the frame including at least a portion of a face;
encoding motion features of the frame into the encoded expression; and
outputting the encoded expression for transmission.

6. A method for training an expression encoder, comprising:
obtaining a first frame and a second frame, the first frame and second frame including at least a portion of a face;
generating a first expression feature for the first frame, the first expression feature representing a first expression of the face;
generating a second expression feature for the second frame, the second expression feature representing a second expression of the face;
generating a first view angle feature for the first frame, the first view angle feature representing a first angle from which the face is viewed from;
generating a second view angle feature for the second frame, the second view angle feature representing a second angle from which the face is viewed from;
crossing at least one of one of the first expression feature and second expression feature or the first view angle feature and the second view angle feature;
determining a first loss value based on the crossing; and
adjusting a feature encoder based on the determined first loss value.

7. The method of claim 6, wherein the first expression matches the second expression, and wherein the first view angle feature is crossed with the second view angle feature, and further comprising:
generating a first reconstructed image based on the crossed first view angle feature;
generating a second reconstructed image based on the crossed second view angle feature;
determining the first loss value based on a comparison between the first reconstructed image and the first frame; and
determining a second loss value based on a comparison between the second reconstructed image and the second frame.

8. The method of claim 7, further comprising determining a third loss value based on the first expression feature and the second expression feature.

9. The method of claim 6, wherein the first angle matches the second angle, and wherein the first expression feature is crossed with the second expression feature, and further comprising:
generating a first reconstructed image based on the crossed first expression feature;
generating a second reconstructed image based on the crossed second expression feature;
determining the first loss value based on a comparison between the first reconstructed image and the first frame; and
determining a second loss value based on a comparison between the second reconstructed image and the second frame.

10. The method of claim 9, further comprising determining a third loss value based on the first view angle feature and the second view angle feature.

11. The method of claim 6, further comprising:
augmenting the first frame to generate an augmented frame;
generating an augmented expression feature based on the augmented frame;
generating an augmented view angle feature based on the augmented frame;
obtaining a semantic labelled version of the first frame;
generating a surrogate expression feature based on the semantically labelled version of the first frame;
generating a surrogate view angle feature based on the semantically labelled version of the first frame; and
generating a third loss value based on a comparison between the augmented expression feature and the surrogate expression feature and a comparison between augmented view angle feature and the surrogate view angle feature.

12. The method of claim 11, wherein augmenting the first frame comprises adjusting color channels of the first frame.

13. An apparatus for generating a representation of a face, the apparatus comprising:
at least one memory; and
at least one processor coupled to the at least one memory, the at least one processor being configured to:
obtain one or more images of a face;
generate an encoded expression representing an expression of the face, wherein predetermined characteristics of the face remain constant relative to the encoded expression;
map the encoded expression to a corresponding expression of a facial model; and
generate the representation of the facial model based on the encoded expression.

14. The apparatus of claim 13, wherein the encoded expression is based on motion features determined based on images of the face.

15. The apparatus of claim 13, wherein the predetermined characteristics of the face include at least one of a view angle, color style, or identity of the face.

16. The apparatus of claim 13, wherein the generating of the representation of the facial model is enhanced based on an audio signal obtained concurrently with the one or more images of the face.

17. The apparatus of claim 13, wherein the processor is further configured to:
receive a frame, the frame including at least a portion of a face;
encode motion features of the frame into the encoded expression; and
output the encoded expression for transmission.

18. An apparatus for training an expression encoder, the apparatus comprising:
at least one memory; and
at least one processor coupled to the at least one memory, the at least one processor being configured to:
obtain a first frame and a second frame, the first frame and second frame including at least a portion of a face;
generate a first expression feature for the first frame, the first expression feature representing a first expression of the face;
generate a second expression feature for the second frame, the second expression feature representing a second expression of the face;
generate a first view angle feature for the first frame, the first view angle feature representing a first angle from which the face is viewed from;
generate a second view angle feature for the second frame, the second view angle feature representing a second angle from which the face is viewed from;
cross at least one of one of the first expression feature and second expression feature or the first view angle feature and the second view angle feature;
determine a first loss value based on the crossing; and
adjust a feature encoder based on the determined first loss value.

19. The apparatus of claim 18, wherein the first expression matches the second expression, and wherein the first view angle feature is crossed with the second view angle feature, and further comprising:
generate a first reconstructed image based on the crossed first view angle feature;
generate a second reconstructed image based on the crossed second view angle feature;
determine the first loss value based on a comparison between the first reconstructed image and the first frame; and
determine a second loss value based on a comparison between the second reconstructed image and the second frame.

20. The apparatus of claim 19, wherein the at least one processor is further configured to determine a third loss value based on the first expression feature and the second expression feature.

21. The apparatus of claim 18, wherein the first angle matches the second angle, and wherein the first expression feature is crossed with the second expression feature, and wherein the at least one processor is further configured to:
generate a first reconstructed image based on the crossed first expression feature;
generate a second reconstructed image based on the crossed second expression feature;
determine the first loss value based on a comparison between the first reconstructed image and the first frame; and
determine a second loss value based on a comparison between the second reconstructed image and the second frame.

22. The apparatus of claim 21, wherein the at least one processor is further configured to determine a third loss value based on the first view angle feature and the second view angle feature.

23. The apparatus of claim 18, wherein the at least one processor is further configured to:
augment the first frame to generate an augmented frame;
generate an augmented expression feature based on the augmented frame;
generate an augmented view angle feature based on the augmented frame;
obtain a semantic labelled version of the first frame;
generate a surrogate expression feature based on the semantically labelled version of the first frame;
generate a surrogate view angle feature based on the semantically labelled version of the first frame; and
generate a third loss value based on a comparison between the augmented expression feature and the surrogate expression feature and a comparison between augmented view angle feature and the surrogate view angle feature.

24. The apparatus of claim 23, wherein, to augment the first frame, the at least one processor is configured to adjust color channels of the first frame.

25. A non-transitory computer-readable medium having stored thereon instructions that, when executed by at least one processor, cause the at least one processor to:
obtain one or more images of a face;
generate an encoded expression representing an expression of the face, wherein predetermined characteristics of the face remain constant relative to the encoded expression;
map the encoded expression to a corresponding expression of a facial model; and
generate a representation of the facial model based on the encoded expression.

26. The non-transitory computer-readable medium of claim 25, wherein the encoded expression is based on motion features determined based on images of the face.

27. The non-transitory computer-readable medium of claim 25, wherein the predetermined characteristics of the face include at least one of a view angle, color style, or identity of the face.

28. The non-transitory computer-readable medium of claim 25, wherein the generating of the representation of the face from the one or more images is enhanced based on an audio signal obtained concurrently with the one or more images of the face.

29. The non-transitory computer-readable medium of claim 25, wherein the instructions further cause the at least one processor to:
receive a frame, the frame including at least a portion of a face;
encode motion features of the frame into the encoded expression, wherein the encoded expression is face and view angle invariant; and
output the encoded expression for transmission.

30. A non-transitory computer-readable medium having stored thereon instructions that, when executed by at least one processor, cause the at least one processor to:
obtain a first frame and a second frame, the first frame and second frame including at least a portion of a face;
generate a first expression feature for the first frame, the first expression feature representing a first expression of the face;
generate a second expression feature for the second frame, the second expression feature representing a second expression of the face;
generate a first view angle feature for the first frame, the first view angle feature representing a first angle from which the face is viewed from;
generate a second view angle feature for the second frame, the second view angle feature representing a second angle from which the face is viewed from;
cross at least one of one of the first expression feature and second expression feature or the first view angle feature and the second view angle feature;
determine a first loss value based on the crossing; and
adjust a feature encoder based on the determined first loss value.
